(19) United States
(12) Patent Application Publication
(10) Pub. No.: US 2008/0069564 A1
(43) Pub. Date: Mar. 20, 2008

(54) Optical Aggregation and Proxy Device

(75) Inventor: Marc Rhael Bernard, Miramar, FL (US)

Correspondence Address: WELSH & KATZ, LTD, 120 S RIVERSIDE PLAZA, 22ND FLOOR, CHICAGO, IL, 60606, US

(73) Assignee: Tellabs Operations, Inc.

(21) Appl. No.: 11/533,565

(22) Filed: Sep. 20, 2006

(51) Int. Cl. H04J 14/00

(52) U.S. Cl. 398/72

(57) ABSTRACT

An optical aggregation device can couple a plurality of optical line terminals to a common plurality of optical network terminals. The device is coupled to the network terminals via a passive optical network. The aggregation device makes it possible to more fully use all of the available bandwidth of the passive optical network.

### FIELD

The invention pertains to passive optical networks. More particularly, the invention pertains to devices and methods that improve bandwidth utilization of such networks.

### BACKGROUND

Passive optical networks (PONs), based on fiberoptic technology have substantial bandwidths which can be used to deliver a variety of video, voice and data services. Unfortunately not all network components support bandwidths such as 622 Mbps provided by Broadband PONs (BPONs), or 2.4 Gpbs provided by Gigabit PONs (GPONs)

Existing PON Networks can provide voice, data, and video services, among other services, between one optical line terminal (OLT) and up to N optical network terminals (ONTs) (where N can range from 1 to >100, depending on the PON technology considered—e.g. BPON, GPON, Ethernet PONs (EPON), Lambda PON, etc). FIG. 1 illustrates an example for such a basic PON, which in this case is a BPON (Broadband PON), providing Voice, Data and Video services. It includes an optical line terminal (OLT), broadband BPON optical fiber, splitter and a plurality of optical network terminals (ONTs).

Extending this example, many OLTs can provide the capability to house multiple interfaces, such as line cards, where each line card can support 1 to N xPON interfaces as illustrated. In FIG. 2, each xPON interface has the capability of communicating with up to N ONTs. The number N depends on the technology (BPON provides a max of 32 ONTs, and GPON provides a max of 128 ONTs, Lambda PON is still begin specified).

The xPON interface must communicate differently with the ONTs depending on the direction of communication (upstream vs. downstream communications). Prior to communicating with one another each ONT must be ranged by the OLT. Ranging is a process known to those of skill in the art where the OLT sends out broadcast messages to the ONTs on the xPON and the ONTs that are ready to be ranged respond to the OLT, after which the two units qualify the distance, equalization delay, assign a timeslot for upstream communications, an ONT ID, etc. The OLT can learn the serial number or can be configured to only range ONTs based on pre-determined (pre-configured) serial numbers and passwords.

After the initial ranging process, downstream communications occur when the OLT sends downstream packets for a pre-determined ONT-ID. The ONTs on the PON observe all the traffic destined for all ONTs on the PON, but only process packets that are destined for their specific ONT-ID. These packets contain the user services as well as the provisioning channel, called the ONT Management Communication Interface (OMCI), that the OLT uses to configure specific services on the ONT, retrieve status information & alarms, upgrade the ONTs, etc.

In the upstream direction, the ONTs are provided specific grant windows in which they are allowed to burst information, whether it be voice data or video services. Within these grant windows, Traffic containers (TCONTs) are configured to deliver specific types of services upstream from the ONT to the OLT. The traffic containers have a predetermined size in bits-per-second, and the OLT provides sufficient grants to allow bursting based on the size of these TCONTs. One or many TCONTs can be configured between the ONT and the OLT.

Encryption and churning can also established between the ONT and the OLT. This is enabled at the OLT, but the ONT generates these encryption-keys (or churning keys) that are returned to the OLT periodically. Only the payload of the downstream xPON data will be encrypted. The overhead of the data, which contains the ONT-ID information that is associated with a given downstream packet, is not encrypted since the ONTs must be able to distinguish the PON data that is destined for their ONT-ID and the PON data this is not destined for them.

Additional information relative to BPON and GPON services can be obtained from ITU-T G.983.x & G.984.x series of specifications, respectively.

As indicated in FIG. 3, OLT systems today can be bottlenecks as they may not have the bandwidth necessary to full support the throughput of multiple PON devices connecting hundreds or thousands of ONTs. A simple example involves the downstream direction on a simple OLT system, which has a backplane that only has the capacity to provide 500 Mbps of total downstream throughput. In this scenario, if the OLT was coupled to a BPON (Broadband PON) or GPON (Gigabit PON) interface to communicate with up to N ONTs on the PON network, there will be a bottleneck in the OLT.

BPON and GPON distribution networks provide up to 622 Mbps and 2.4 Gbps, respectively, of downstream throughput capacity, and future xPON technologies may provide more capacity. Ultimately, when adding these BPON or GPON devices to an OLT with limited overall capacity, there is excess bandwidth capacity that will potentially never be used or taken advantage of and the full capacity of the PON itself will never be realized. In this simple example, the excess capacity on the BPON is 122 Mbps.

A slightly more complex approach occurs when there are multiple PON interfaces (up to NUMPON interfaces) available on the same OLT device. Assume that each PON interface has PONBW Mbps of downstream throughput available, whereas the OLT device has OLTBW Mbps of downstream throughput available. Again, a problem may occur when the aggregate throughput of the NUMPON interfaces is greater than the capabilities that the OLT can provide, as shown below:

```
If [NUMPON × PONBW] is greater than OLTBW,
      then Excess Capacity remains on the PON networks,
      and the OLT is essentially a bottleneck.
```

Oftentimes, this may not be problem because the service provider expects that the data services offered to a customer are High Speed Internet (HSI) services, which can be concentrated due to the bursty nature of this type of traffic. When this occurs, the customer can determine that a given concentration ratio (CONCRATIO) can be assumed—At this time, the Expected data traffic from a given PON at any given time is divided by the concentration ratio. Therefore, the above equation becomes:

```
If [NUMPON × PONBW] / CONCRATIO is greater than OLTBW,
      then Excess Capacity remains on the PON networks,
      and the OLT is still a bottleneck.
```

Thus, as the expected CONRATIO increases, the overall value of [NUMPON×PONBW]/CONCRATIO becomes smaller. However, as the expected number of PON interfaces supported on a given OLT increases, the term [NUMPON×PONBW]/CONCRATIO will ultimately increase as well. These values depend on the customer deployment requirements for CONCRATIO and the desired number of PON cards to be used within the same OLT. Due to cost issues, customers may try to get the most out of a system by increasing NUMPON.

Expected throughput rates for HSI are not initially expected to be very high, and therefore the Bandwidth used per subscriber is not high—this ultimately results in low PONBW values. Furthermore, this HSI traffic is currently very bursty (non-constant) traffic, which allows the service provider to initially assume a high value for CONRATIO.

An example of Concentration ratio is as follows—if there is 622 Mbps of downstream throughput available on a PON for 32 ONTs, then a 1:1 concentration ratio would mean that each subscriber can get a max of 622 Mbps/32=19.44 Mbps. This means that the concentration ratio is 19.44 Mbps×32/622 Mbps=1. However, if each ONT is to support a max of 100 Mbps of HSI bursty traffic, then this scenario would require concentration. The concentration ratio in this case would be 100 Mbps×32/622 Mbps=5.14. However, if the OLT only supports 500 Mbps as the example provides above, then the CONRATIO would 100 Mbps×32/500 Mbps=6.4. The same scenario can be used across multiple PONs, or for the entire OLT, where CONCRATIO=[Total Peak Bandwidth subscribed by all subtended ONTS]/[Maximum OLT Throughput Capacity]

Per-user throughput rates are expected to increase and the type of subscriber traffic is also expected to change from bursty to less bursty type of traffic due to changes in the end-user demand for different applications offered on the Internet. An example of this migration includes current basic surfing to an increase in Music downloads, to a gradual migration to large file size downloads such as Movies or other programs available via Peer-to-Peer applications or through dedicated websites such as APPLE's itunes.com. Eventually, end-user subscribers may be downloading, on a real-time basis, movies from different websites.

Real-time viewing of these services requires a more constant bandwidth requirement than the legacy web-surfing requirements. Therefore the CONCRATIO expected for a given PON will likely have to decrease or never go any higher than a pre-determined limit. Furthermore, the number of PON interfaces supported on a given OLT system is also expected to increase, as OLTs typically support a large number of Line cards, on which the PON interfaces reside.

Relative to the original problem where the term [NUMPON×PONBW/CONCRATIO] gradually becomes greater than OLTBW, if the customer eventually adds too many PON interfaces to an OLT, then the OLTBW will now become the upper limit for the BW that can be shared across all PON interfaces. The Excess capacity per PON will now increase as the number of PON interfaces increases beyond a certain limit (MAX NUMPON) is reached.

As illustrated in the graph of FIG. 4, the Maximum number of PON interfaces on the OLT (MAX NUMPON) occurs when the Bandwidth required per PON intersects with the OLTBW.

Thus, [MAX NUMPONs=OLTBW×CONCRATIO/PONBW]

If the NUMPONs exceeds MAX NUMBPONs, then the OLT becomes a bottleneck once again, and the OLT BW that can be dedicated to each PON begins to decrease. At this point, the excess capacity per PON increases. If the OLT's overall line card capacity makes it such that the allowable number of PON Line cards is much greater than MAX NUM PONS, then the OLTBW available per PON card can be very low.

There are as a result potential problematical and severe bandwidth mismatches between optical network components. There is thus a need for devices and methods that can address and mitigate those mismatches.

Preferably devices could be incorporated into networks to fully utilize available PON bandwidth while also efficiently using available bandwidth (which might be less) of other devices such as OLTs.

### SUMMARY

An apparatus in accordance with the invention includes a first plurality of bidirectional ports. Members of the first plurality receive optical signals, each of the signals has a respective throughput rate. The apparatus includes another bidirectional port that transmits combined optical signals at a higher throughput rate.

### BRIEF DESCRIPTION OF THE DRAWINGS

FIG. 1 illustrates a prior art passive optical network;

FIG. 2 illustrates a prior art interface configuration for passive optical networks;

FIG. 3 illustrates aspects of a known BPON network;

FIG. 4 is a graph relating bandwidth to a number of passive optical network interfaces in an OLT;

FIG. 5 illustrates aspects of a system which embodies the present invention;

FIG. 6 illustrates additional functional and structural aspects of the system of FIG. 5;

FIG. 7 is a diagram illustrating one way in which an optical aggregation device in accordance with the invention can be configured;

FIG. 8 illustrates a different way in which an optical aggregation device in accordance with the invention can be configured;

FIG. 9 illustrates yet another way in which an optical aggregation device in accordance with the invention can be configured;

FIG. 10 illustrates steps of a process of user side interface configuration;

FIG. 11 illustrates steps of a service side configuration;

FIG. 12 illustrates another system which embodies the invention;

FIG. 13 illustrates yet another system which embodies the invention;

FIG. 14 illustrates another system which embodies the present invention;

FIGS. 15A, 15B and 15C illustrate various passive optical networks, some of which embody aspects of the present invention; and

FIGS. 16A, 16B and 16C taken together illustrate a process of technology migration from a BPON network to a GPON network.

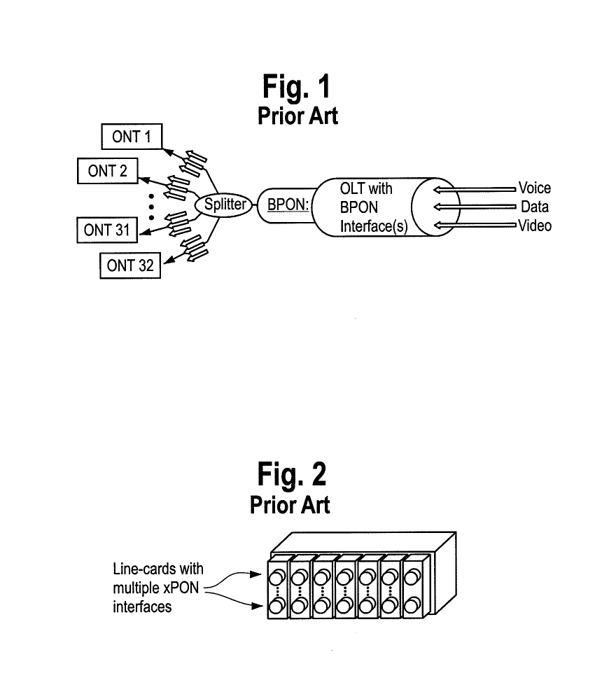

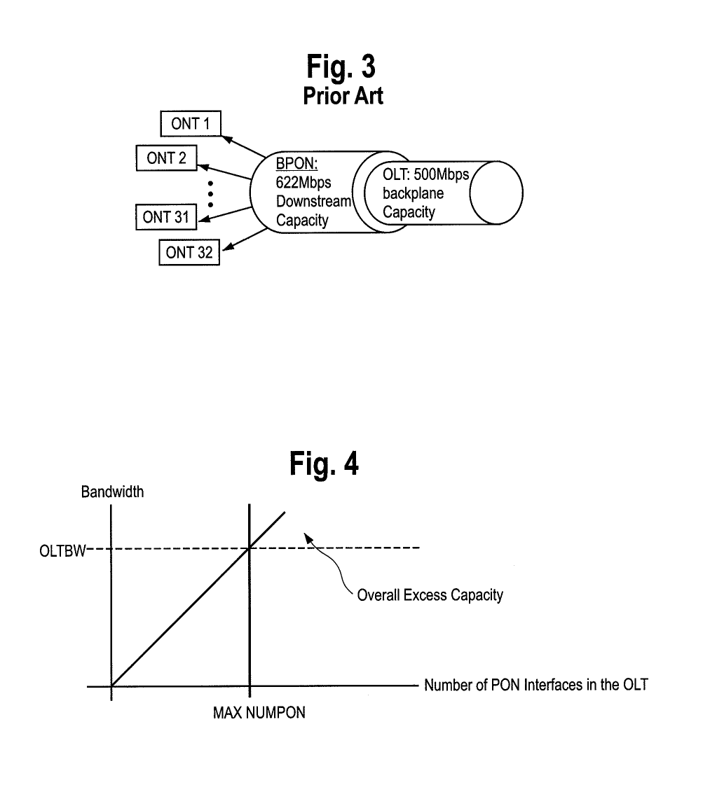

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

In accordance with one embodiment of the invention, an active device, an OLT Aggregation Device (OAD), is connected to two or more OLTs on an Access Network Interface (ANI). Multiple OLTs can communicate with a given set of M ONTs on a User Network Interface (UNI) side of a separate PON. The OAD communicates individually with up to M ONTs. It resembles a single OLT while aggregating all services provided by all OLTs connected on the ANI side. This structure enables the OAD to function as a Proxy for the OLTs when communicating with ONTs, and similarly to function as a proxy for the ONTs when communicating upstream with the OLTs.

A disclosed method can convert the physical type of PON technologies being used. For example, the ANI interface of the OAD can be BPON, and the UNI interface can be GPON, or vice-versa. This aspect of the invention provides for easier migration to GPON from BPON, for example. Thus, the service provider can either upgrade the OLT to GPON while still communicating with BPON ONTs, or can first upgrade the GPON ONTs, while still communicating with a BPON OLT.

In another aspect of the invention, an active device that is connected to two or more OLT devices allows multiple OLTs to communicate with the same set of ONTs on a given PON. For example, one of the OLTs can be dedicated to provide Voice and Data services to all ONTs on the PON. The 2^{nd} OLT can be dedicated to provide Video-only services to the ONTs. Up to N OLTs can be coupled to an OLT PON Aggregation device (OAD) on the ANI side while up to M (M is limited by the xPON technology used) ONTs can be coupled on the ONT side.

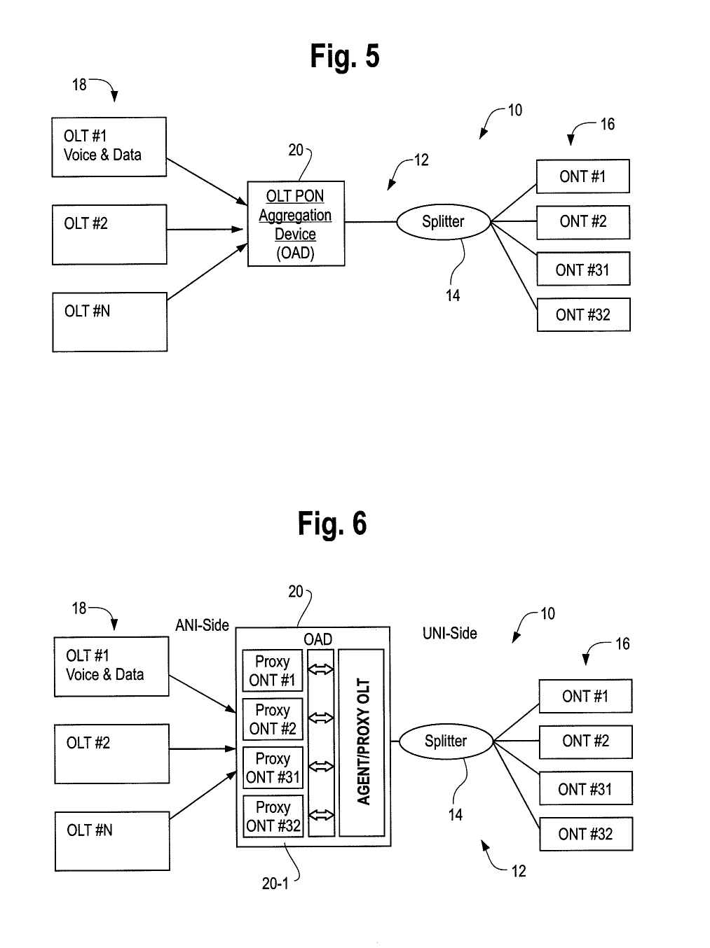

FIG. 5 illustrates a system 10 in accordance with the invention. In system 10 a PON 12 is coupled via a splitter 14 to a plurality of optical network terminals indicated generally at 16. A plurality of optical line terminals indicated generally at 18 is coupled via an OLT PON Aggregation Device (OAD) 20 to the PON 12.

The OAD 20 provides a bandwidth difference compensating interface between the members of the plurality 18 and the PON 12. The members of the plurality 18 can each communicate with a common plurality 16 of ONTs using the PON 12.

Those of skill will also understand that an OAD can be configured to support multiple pluralities of PONs and ONTs without limitation. Various OAD implementations come within the spirit and scope of the invention.

OAD 20 performs various functions to provide aggregation. The first is to act as an interim ONT device to all the OLTs and then act as an AGENT/PROXY OLT to all the Subtended ONTs. FIG. 6 illustrates a block-diagram of these logical functions.

The OAD 20 includes a control element 20-1 which could be implemented at least in part with one or more programmed processors and associated control software. Control element 20-1 along with other opto-electronic components as would be understood by those of the art emulate the plurality of ONTs with respect to each of the optical line terminals 18, located on the access network interface side (ANI-side). Additionally, the control element 20-1 along with associated opto-electronic components emulate an OLT-type interface on the user network interface-side (UNI-side) which is in turn coupled to the network 12. Thus the OAD 20 functions as an individual OLT on the UNI-side while communicating with all applicable ONTs of the plurality 16.

To be capable of detecting all ONT provisioning information of members of the plurality 16, the OAD 20 would have to know about all ONT serial number and password information of all ONTs to range with the different OLTs. The OAD 20 could receive all of the configuration information from the OLTs in plurality 16. Once the OAD has detected all ONT information and has ranged with the first OLT, it can then attempt to range all of the Physical ONTs on the UNI Side. Other scenarios come within the spirit and scope of the invention.

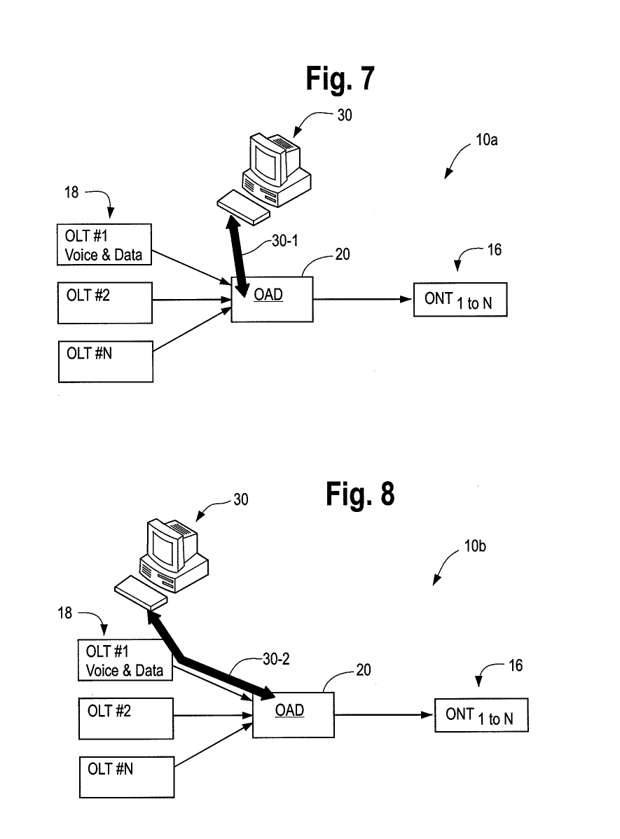

Various methods are available for configuring the OAD 20. FIGS. 7 through 9 illustrate several different exemplary configurations. It will be understood that other configurations come within the spirit and scope of the present invention.

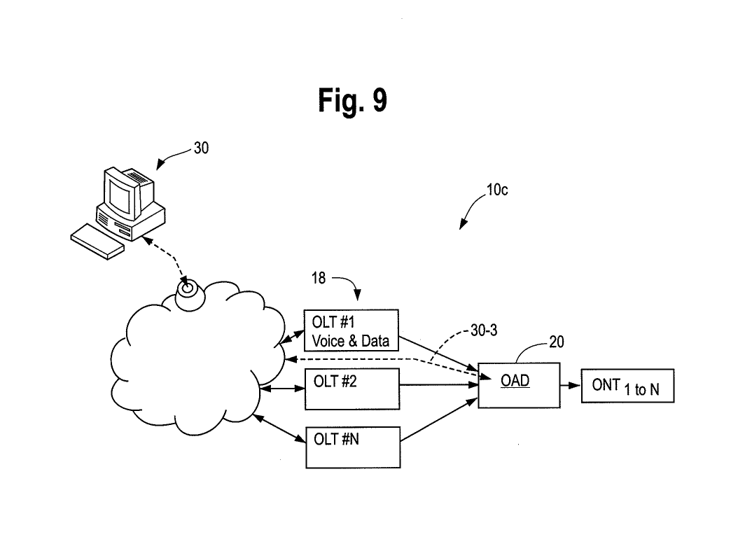

As illustrated in FIG. 7, the OAD 20 can be configured by an operator using a computer 30 coupled to the OAD 20 via a network management interface and channel 30-1. In FIG. 8, the operator can configure the OAD 20 using the computer 30 and a communications channel 30-2 from one of the OLTs, illustrated as OLT1. Alternately, as illustrated in FIG. 9, the computer 30 can be coupled to OAD 20, out of band, using a communications channel, such as the channel 30-3 which is outside of the OLT network. For example, computer 30 could be coupled to channel 30-3 by a computer network 32. The network 32 could be an intranet or the Internet.

Different methods to bring up the communications between the multiple OLTs 18 and a single ONT from the plurality 16 come within the spirit and scope of the invention.

The first mechanism only requires a direct communication channel to the OAD 20.

In another approach, one or many of the OLTs 18 can also communicate with the OAD 20. This could be implemented via a different Fiber connection or alternatively on a different Lambda. Again, the Nth OLT can still attempt to range the Proxy ONTs from the OAD 20 in various ways. Once the OAD 20 has ranged with the Nth or last OLT, it will take the new provisioning/configuration information from the Nth OLT and send it to the applicable ONTs.

So for example, if the 1^{st} OLT from the plurality 18 ranged all Proxy ONTs, and the OAD 20 immediately ranged the Physical ONTs, the configuration, VCCs/GEM Ports, TCONTs would be identical on both the UNI side as it is on the ANI side. When the OMCI configuration information is setup, the OAD 20 would have to transmit the information to the ONTs. An alternative approach would have the OAD 20 interpret all OMCI messages from all OLTs and coordinate the applicable ME IDs and other information to the Physical ONTs.

In another configuration, the 1^{st} OLT function as a Master OLT and is aware that a 2^{nd} OLT will be communicating with the OAD. The Master OLT would have knowledge of all configuration parameters (e.g. OMCI) necessary to communicate with the ONTs. The second OLT would simply need to range the PROXY ONTs, setup the GEM Ports or VCCs and send down the applicable information.

In yet another approach, the OAD 20 can be configured so as to be completely transparent to all OLTs 18. The user would manage and configure the OAD 20 in an out-of-band channel that could travel through a dedicated data channel through one of the OLTs. The OLTs themselves would not manage this channel any differently than any other end-user services which were also configured.

In another embodiment, it is possible to use bandwidth limitations of a DATA/Voice OLT and use the same IP Video OLT to service multiple OADs. This is possible because the IP Video Channel Lineup can be shared by all PONs.

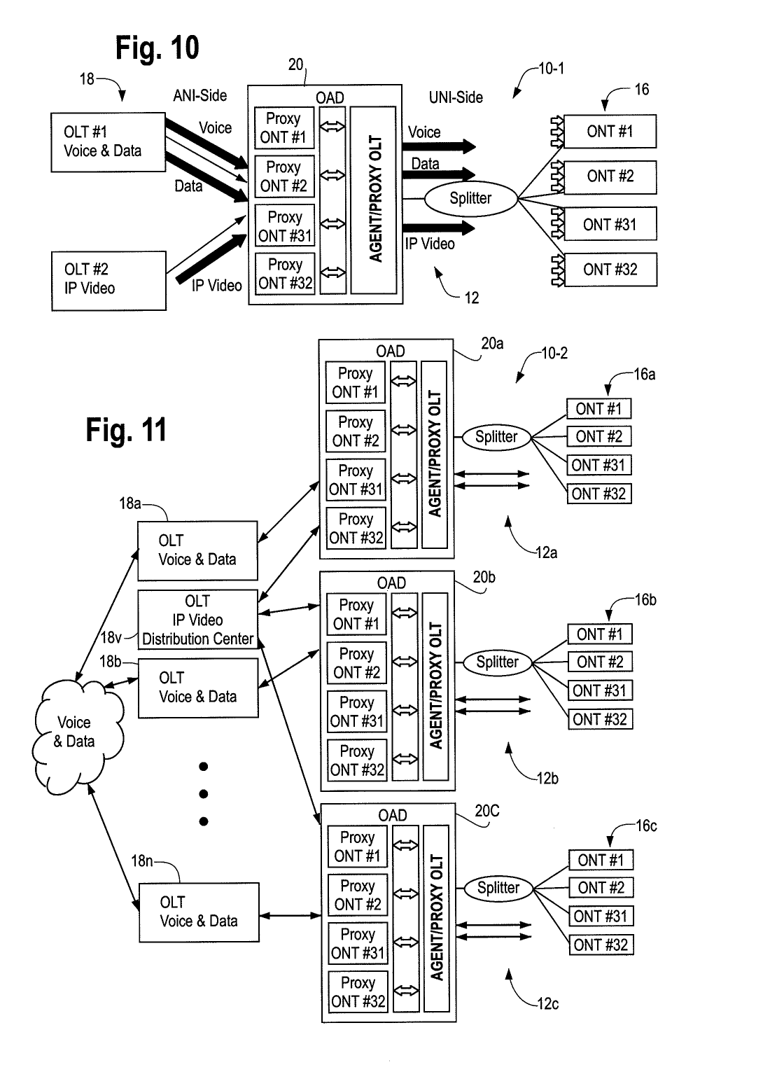

As illustrated in FIG. 10, in system 10-1 Voice and Data received from OLT1 of plurality 18 can be combined with IP Video from OLT2 at OAD 20. In this instance, the OAD 20 can couple Voice, Data and IP Video from OLT1 and OLT2 to network 12 for distribution to the ONTs of plurality 16. In this particular configuration, while each of the ONTs might receive different voice and data streams than those received by other ONTs, they would all receive a common IP Video feed.

System 10-2 of FIG. 11 is similar to system 10-1 but includes multiple optical networks 12a, b, c which can be configured differently to take advantage of the benefits of the OAD. In this above example, a single OLT 18n provides all the Video services. Other OLTs 18a-n provide voice and data services to the respective networks. This configuration takes advantage of a single video distribution center, and removes the need to have multiple video distribution points from each individual OLT interface. This saves bandwidth and avoids bottlenecks within the given OLTs.

Unlike the structure of system 10-2 of FIG. 11, absent the OADs 20a, b, c in order to provide common video to the members of the plurality 16a, 16b and 16c it would be necessary to couple that video through each of the OLTs 18a, 18b . . . 18n which also provide Voice and Data services. This is disadvantageous in that each of the individual OLTs would have to be able to address the Video services which makes them more complex. One of the advantages of system 10-2 is that OLT 18n can provide all of the required complex services associated with Video feed.

Thus, as explained above, system 10-2 of FIG. 11 is particularly advantageous in that using the aggregation devices 20a, b, c a separate OLT can be dedicated to providing Video services which in turn provides 25 percent more bandwidth on the network side then would be the case where the aggregation devices 20a, b, c were not used.

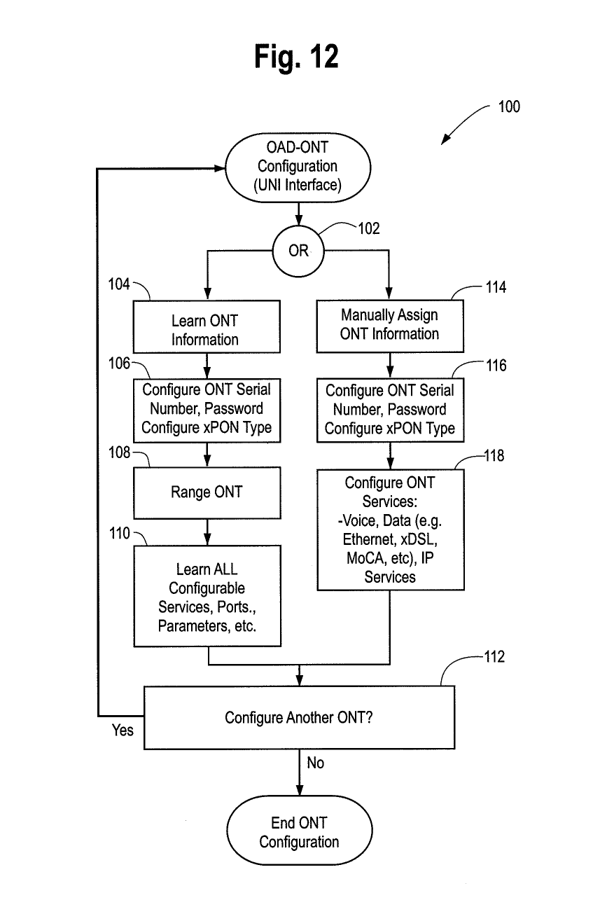

FIG. 12 illustrates an exemplary process 100 whereby the UNI side can be configured. In step 102 a decision is made as to whether the operator, functioning perhaps through computer 30, has elected to have OAD 20 function automatically or manually.

Where automatic functioning has been elected, the OAD 20 obtains specification information, indicated generally in step 104 from the next ONT in the plurality 16. In this regard, step 106, OAD 20 can carry out a configuration process relative to the respective ONT. In step 108 the OAD can range the current ONT.

In step 110, OAD 20 can obtain information concerning services, ports, related parameters and the like. In step 112, a determination can be made as to whether the OAD 20 needs to configure additional ONTs. The process is repeated until OAD 20 obtains information pertaining to and configures all of the ONTs in the plurality 16.

Alternately, where a decision has been made to manually assign ONT information step 114, the OAD 20 can configure specification information for the respective ONT from the plurality 16 as well as the network 12, step 116. In step 118, the OAD 20 can configure the respective ONT from the plurality 16 relative to services. The next ONT can then be configured, step 112.

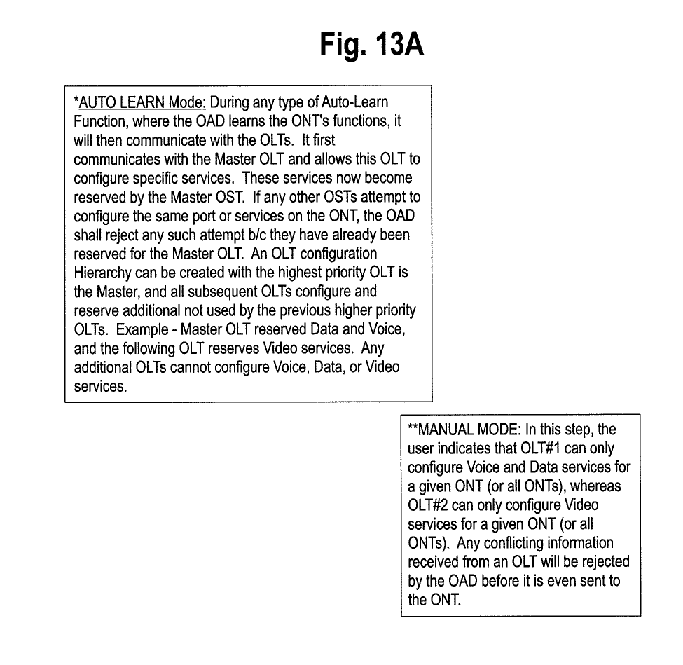

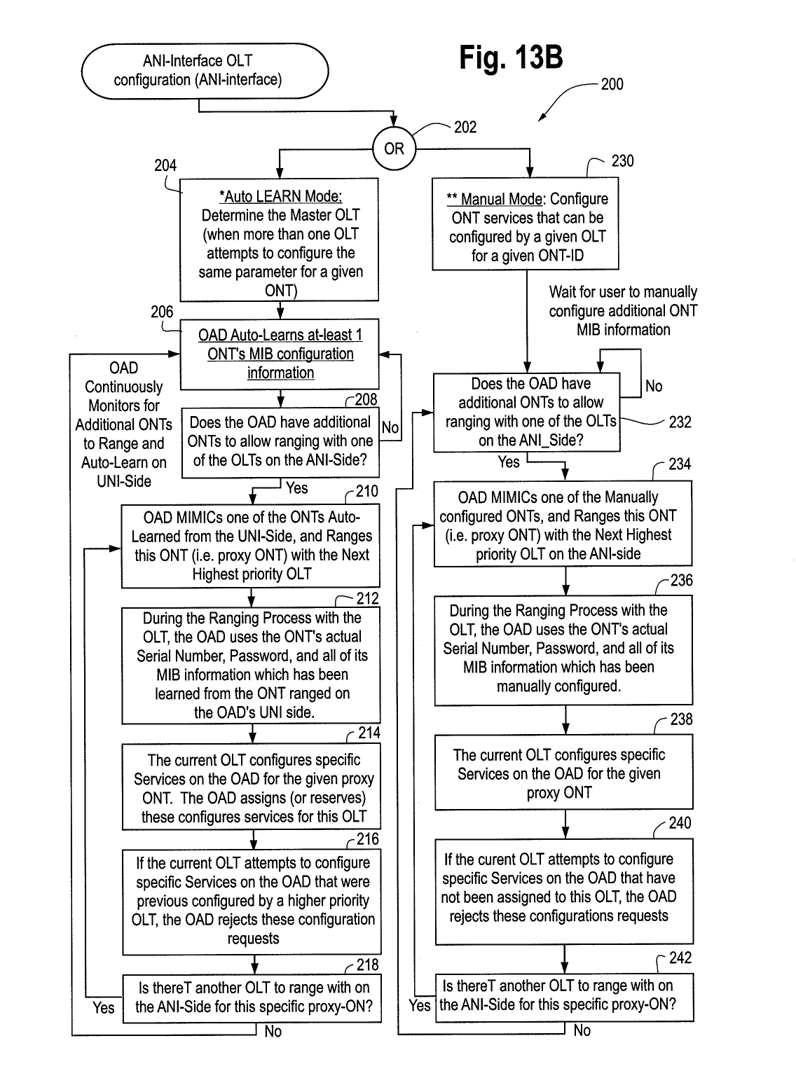

FIG. 13 illustrates an exemplary process 200 for OLT configuration by OAD 20. Initially, step 202 a decision is made as to whether automatic or manual configuration is to be carried out. If automatic configuration is to be carried out, in step 204 OAD 20 establishes a master OLT. In step 206, the OAD 20 obtains configuration information relative to at least one of the ONTs.

A decision is made in step 208 as to whether additional ONTs are available to allow ranging with one of the OLTs. In step 210, the OAD 20 mimics the characteristics of one of the ONTs from the plurality 16 and ranges this ONT with the next highest priority OLT. In step 212, the OAD 20 uses information previously obtained for the respective ONT via the process 100. In step 214, the current OLT configures specific services for the respective Proxy ONT. Those services would then be associated with the physical respective ONT.

In step 216, any attempt by the current OLT to configure previously assigned services is rejected. In step 218, a determination is made as to whether the OAD 20 has ranged with all members of the plurality 18.

Alternately, where the manual mode has been selected in step 202, the user configures, via computer 30, services for a respective ONT, or all of the ONTs, that can be configured by a given OLT, step 230. In step 232, a decision is made as to whether OAD 20 has any additional ONTs associated therewith to allow ranging with one of the OLTs. If so, in step 234, OAD 20 mimics one of the manually configured ONTs from the plurality 16 and ranges that ONT with the next highest priority OLT, from the plurality 18. In step 236, during this ranging process, OAD 20 uses the ONTs' actual data and other information which may have been manually configured. In step 238, the current OLT, from the plurality 18, configures specific services on the OAD 20 for a respective one of the Proxy ONTs. In step 240, attempts to configure specific services not assigned to the respective OLT are rejected. In step 242, a determination is made as to whether there is another OLT to range with relative to the respective Proxy ONT.

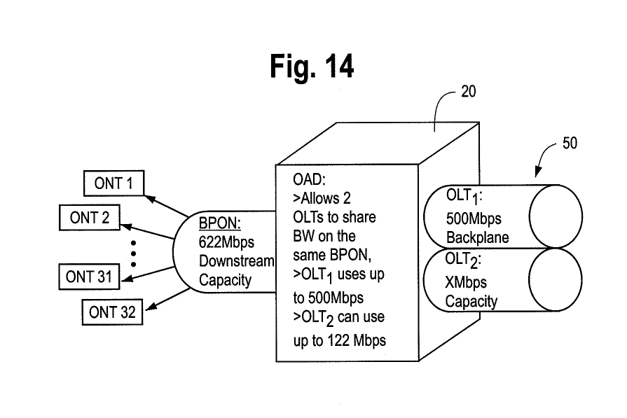

FIG. 14 illustrates in configuration 50 an example of how a 2^{nd} OLT can be dedicated to service the excess BW on the given PON interface using OAD 20. Using one or multiple OADs, this 2^{nd} OLT can service one or multiple PON interfaces or OLTs, depending on the user's configurations. The two OLTs can now provide the required 622 Mbps to the given BPON network in this scenario.

Another problem that is sometimes seen in a network is that the OLT does not provide the throughput for dedicated bandwidth for constant streams, such as Switched Digital Video or IGMP (internet group multiple protocol) Streams. Having these dedicated, constant bandwidth streams in one OLT would use up all the bandwidth and limit the remaining bandwidth available for other services such as High Speed Internet (HSI) services. So, continuing the approach described above, assume that IP Video requires a constant BW of IGMPBW. This dedicated IP Video BW cannot be concentrated, and therefore, the equations provided above are no longer valid.

In an IGMP setting, an OLT can provide IGMP streams to one or multiple PONs. However, only specific channels that are being viewed on a given PON will require that stream to be sent on that PON. Therefore, another variable, called PONIGMPBW must be considered.

Assume this PONIGMPBW is an average BW used on a given PON. In most scenarios, PONIGMPBW is less than IGMPBW but is at most equal to IGMPBW when all available channels are streaming simultaneously on a PON. Similarly, there are possible deployment scenarios where the entire channel line-up is delivered directly onto the entire PON regardless of who is watching this channel line-up. In this case PONIGMPBW=IGMPBW.

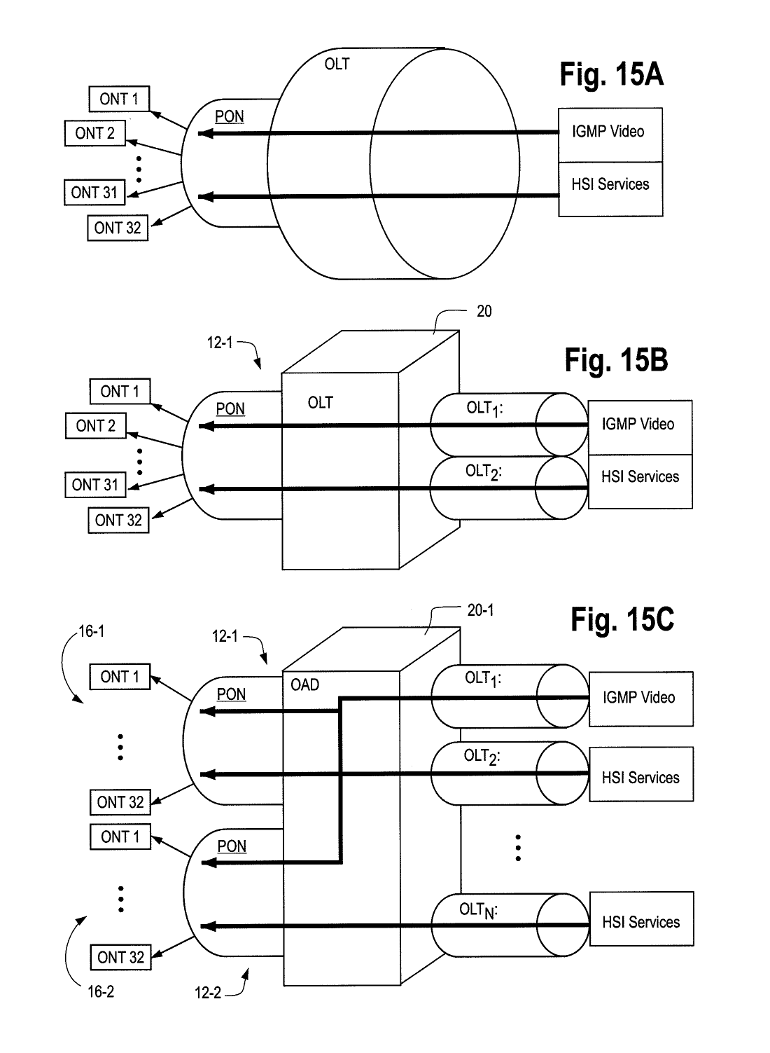

Now, there are now different scenarios to consider. The first is when the dedicated IGMP bandwidth is served by the same OLT that services all the HSI bandwidth as illustrated in FIG. 15A. The second is when the dedicated IGMP bandwidth is served by a separate OLT as in FIGS. 15 B, C.

In FIG. 15A, the IGMP bandwidth uses up more of the existing OLT bandwidth, and therefore limits the amount of usable bandwidth for HSI services. In the systems of FIGS. 15B, C, the OAD 20 supports a separate OLT, that is dedicated for IGMP video services, to be combined with the existing OLT services.

In FIG. 15A, the OLTBW available for HSI is decreased by IGMPBW, and the original equation above must now be modified to take this into consideration:

NUMPON×(PON_HSI_BW)/CONCRATIO must now be less than OLT_HSI_BW, which is equal to [OLTBW−IGMPBW].

As we can see, this decrease in the OLTBW to be used for HSI due to the presence of dedicated IGMP video (increased bottleneck potential) has an added impact on the Excess PON Bandwidth capacity that will be incurred due to the OLT bandwidth restrictions. As the channel line-up increases or the bandwidth per IGMP channel increases, then IGMPBW increases and the potential for a bottleneck also increases.

In the system of FIG. 15B, OLTs 1, 2 can communicate with the same plurality of ONTs using a common passive optical network 12-1. Excess network capacity can be used (and not lost) and OLT 1 bandwidth is used efficiently.

FIG. 15C illustrates a configuration where an OAS 20-1 can couple traffic from a plurality of OLTs via two PONs 12-1, 12-2 to two different pluralities of ONTs 16-1, -2. In this configuration, OLT1 is a source of common video for all ONTs.

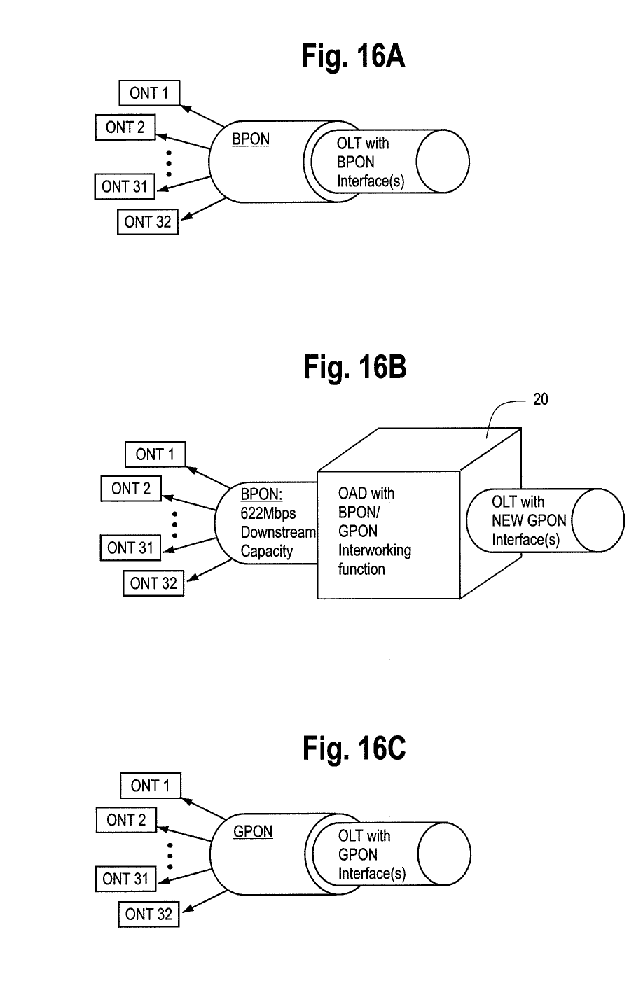

Optical aggregation devices which embody the present invention, such as device 20, can be incorporated in a process of upgrading the physical type of passive optical network technology being used. FIG. 16A, 16B and 16C illustrate three steps of such a process.

FIG. 16A illustrates an initial broadband passive optical network having at least one OLT coupled thereto and a plurality of ONTs coupled thereto. A system operator may want to migrate from a broadband passive optical network technology to a GPON type system.

FIG. 16B illustrates an interim step which incorporates OAD 20 with a new OLT having an interface for the proposed GPON network. The structure of FIG. 16B continues to use the original broadband BPON system.

In a third step of the process, illustrated in FIG. 16C, the OAD 20 and original BPON network can be replaced with a broader band upgraded GPON network which interfaces directly with the upgraded OLT. In this circumstance, the OAD 20 which has served an interim purpose is no longer necessary.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. An apparatus comprising:
a multi-port structure having a first plurality of bidirectional ports that receive optical signals, each of the signals has a respective throughput rate, the structure includes another bidirectional port that transmits combined optical signals at a higher throughput rate.

2. An apparatus as in claim 1 which includes a control element, the element couples optical signals from members of the first plurality to the another port from which they are transmitted.

3. An apparatus as in claim 2 where members of the first plurality each present a passive optical network-type interface to received optical signals.

4. An apparatus as in claim 3 where the interface comprises an optical network terminal-type interface.

5. An apparatus as in claim 2 where the another port presents a provider side-type interface to received optical signals.

6. An apparatus as in claim 2 which includes a passive optical network coupled to the another port.

7. An apparatus as in claim 6 which includes at least one optical line terminal coupled to a member of the plurality.

8. An apparatus as in claim 3 which includes a plurality of optical line terminals coupled to respective members of the first plurality.

9. An apparatus as in claim 8 which includes a passive optical network coupled to the another port.

10. An apparatus as in claim 9 which includes a plurality of user interface units coupled to the network.

11. An apparatus as in claim 10 where at least some of the user interface units comprise optical network terminals.

12. An apparatus as in claim 11 where the control element combines received optical signals from a plurality of optical line terminals and transmits a combined optical signal to at least one optical network terminal of the passive optical network.

13. An optical communication system comprising;
a passive optical network with a first end and a plurality of second ends;
a plurality of user service terminals coupled to the network at respective second ends;
a plurality of service provider terminals;
a bi-directional many-to-one interface coupled to the first end of the network and to members of the plurality of service provider terminals with content from providers delivered to the service provider terminals coupled via the interface and the network to at least some of the user service terminals.

14. A system as in claim 13 where the service provider terminals each have an associated bandwidth with a bandwidth of the network being greater than each of the associated bandwidths.

15. A system as in claim 13 where the interface includes elements that combine traffic received from at least two different service provider terminals and couple that combined traffic to the passive optical network.

16. A system as in claim 13 where the interface includes a control element which ranges members of the plurality of service provider terminals.

17. A system as in claim 13 where the interface comprises a plurality of ports each of which emulates communications with the network.

18. A system as in claim 17 where the interface includes at least one port, coupled to the network, which emulates communications with at least one of the service provider terminals.
